(19) United States
(12) Patent Application Publication
(10) Pub. No.: US 2004/0091413 A1
(43) Pub. Date: May 13, 2004

(54) Process for purifying ammonia

(76) Inventors: Kenji Otsuka, Kanagawa (JP); Satoshi Arakawa, Kanagawa (JP); Takashi Kasaya, Kanagawa (JP); Tomohisa Ikeda, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/691,697

(22) Filed: Oct. 24, 2003

(30) Foreign Application Priority Data
Oct. 24, 2002 (JP) 2002-309134

(51) Int. Cl. C01C 1/02

(52) U.S. Cl. 423/352

(57) ABSTRACT

A process for purifying ammonia removing impurities contained in a crude ammonia which comprises contacting a crude ammonia with a purification agent comprises: a manganese oxide (1), and at least one kind of metal oxide (2) selected from vanadium oxide, chromium oxide, stannic oxide, zirconium oxide, bismuth oxide, niobium oxide and tantalum oxide as an effective component; wherein a ratio between a number of manganese atom and a number of the entire metallic atoms of the effective component is 80 to 99%; and preferably further contacting with a synthetic zeolite. The purification agent enables to remove a slight amount of impurities such as oxygen, carbon dioxide and moisture to an extremely low concentration, and any repeated reproduction of the purification agent does not reduce the capability of removing impurities in crude ammonia, and the longevity of the purification agent was remarkably elongated than the conventional purification process.

### BACKGROUND OF THE INVENTION

1. Technical Field of the Invention

The present invention relates to a process for purifying ammonia. More particularly, the present invention pertains to a process for purifying ammonia, competently capable of removing impurities such as oxygen, carbon monoxide, carbon dioxide, water, etc., that are contained in crude ammonia to an extremely low concentration.

2. Prior Art

Late years, gallium nitride-based compound semiconductors are widely employed for elements such as a light emitting diode or a laser diode, etc. As for the production process for the gallium nitride-based compound semiconductors, it is usually put into practice by subjecting a gallium nitride-based compound to a vapor phase growth on a substrate made of sapphire or the like by means of MOCVD process. Examples of material gas employed for the process include a trimethylated Group III element in the Periodic Table such as trimethyl gallium, trimethyl indium and trimethyl aluminum and besides, ammonia of a Group V element in the Periodic Table. Accompanying the progress in film formation technique in recent year, the foregoing material gasses are forcefully required to have an extremely high purity. Because of the requirement and a large amount to be used, a development of a process for purifying ammonia capable of continuously feeding highly pure ammonia is seriously demanded.

In general, ammonia available on the market for industrial use contains oxygen, carbon monoxide, carbon dioxide, water, etc. Further, the ammonia having a comparatively high purity is marketed in the form obtained by further distilling or rectifying the ammonia available on the market, or in the form obtained by further diluting with a highly pure inert gas. However, since the ammonia to be used as a feed gas in a semiconductor process and the like as mentioned above is required to have an extremely high purity, there has hitherto been developed a process for further purifying ammonia having a relatively high purity obtained by further distilling or rectifying ammonia for industrial use.

As a conventional process for purifying ammonia, for example, (1) Japanese Patent Application Laid-Open No. HEI 6-024737 discloses an ammonia purifying process in which carbon dioxide gas in crude ammonia is adoptively removed by passing crude ammonia through a solid alkali layer maintained at such a temperature at which the solid alkali is no longer dissolved due to the deliquescent property of the solid alkali and also at the temperature as lower than the melting point thereof. (2) Japanese Patent Application Laid-Open No. HEI 9-142833 discloses an ammonia purifying process in which moisture in crude ammonia into contact with BaO as a simple substance or a mixture comprising BaO as a principal component under the condition of substantial room temperature.

Additionally, (3) Japanese Patent Application Laid-Open No. HEI 5-124813 discloses an ammonia purifying process in which oxygen contained in crude ammonia is removed by bringing the crude ammonia into contact with a catalyst comprising nickel as a principal component, (4) Japanese Patent Application Laid-Open No. HEI 6-107412 discloses an ammonia purifying process in which carbon monoxide and carbon dioxide that are contained in crude ammonia are removed by bringing the crude ammonia into contact with a catalyst comprising nickel as a principal component. Further, (5) Japanese Patent Application Laid-Open No. 2002-037623 discloses a process for purifying ammonia which comprises bringing crude ammonia into contact with a catalyst comprising manganese oxide as an effective ingredient to remove oxygen and/or carbon dioxide that are contained as impurities in the ammonia, etc.

Furthermore, (6) WO 00/20330 discloses a method of removing a contaminant from a gas stream of hydride gas which comprises contacting the gas stream with a quantity of high surface area of metal oxide substrate having a surface area of at least 100 m²/g, wherein the metal oxide comprises an oxide of barium, calcium, iron, lithium, manganese, molybdenum, potassium, rhenium, sodium, strontium, titanium, tungsten, etc. The foregoing purification agents are preferable not only because reproduction and reuse of the purified ammonia contribute the efficient utilization of resources, but also because troublesome works such as refill or pretreatment of the purification agents are tremendously saved and highly pure ammonia is easily continuously fed.

Still further, (7) Japanese Patent Application Laid-Open No. 2000-044228 discloses a method for purifying ammonia by bringing a part of purified ammonia into contact with an ammonia decomposition catalyst and using the resultant hydrogen containing decomposed gas for regenerating a nickel catalyst. Still further, (8) Japanese Patent Application Laid-Open No. 2000-169138 discloses a purification of ammonia by bringing ammonia into contact with a nickel catalyst under heating to regenerate the nickel catalyst.

However, the ammonia purifying processes disclosed in (1) Japanese Patent Application Laid-Open No. HEI 6-024737 and (2) Japanese Patent Application Laid-Open No. HEI 9-142833 have suffered from the disadvantages in that the process disclosed in (1) can remove only carbon dioxide gas and the process disclosed in (2) can remove only moisture, each of the processes must be frequently combined with another process to purify the ammonia in order that the process is employed in a semiconductor processes. Moreover with regard to the ammonia purifying processes disclosed in (3) Japanese Patent Application Laid-Open No. HEI 5-124813 and (4) Japanese Patent Application Laid-Open No. HEI 6-107412, in the case of a high contact temperature between the catalyst and ammonia, there is a fear of hydrogen generation due to ammonia decomposition, hence necessitating purifying the ammonia by maintaining the contact temperature at around ordinary temperature. Further, although the process for purifying ammonia disclosed in (5) Japanese Patent Application Laid-Open No. 2002-037623 enables to remove a slight amount of impurities such as oxygen, carbon dioxide and moisture to an extremely low concentration, the removing capability for impurities among crude ammonia is not sufficient. At the same time, it has suffered from the disadvantages in that many returns of reproduction of the purification agent degrade the purification agent and further reduces the removing capability for impurities among crude ammonia, that is, removing amount for impurities per unit amount of the purification agent. Furthermore, although the method of removing a contaminant from a gas stream of hydride gas disclosed in (6) WO 00/20330 teaches that one desirable mixture with a quantity of high surface area is of manganese oxides and iron oxides in a ratio of about 80%-85% manganese oxides to 15%-20% iron oxides, the removing capability for impurities among crude ammonia is not sufficient similarly with the process for purifying ammonia disclosed in (5). At the same time, it has also suffered from the disadvantages in that many returns of reproduction of the purification agent degrade the purification agent and further reduces the removing capability for impurities among crude ammonia.

Under such circumstances, an object of the present invention is to provide a process for purifying ammonia, capable of removing impurities that are contained in ammonia each in a slight amount to an extremely low concentration, capable of preventing degradation of the removing capability for impurities even after many returns of reproduction of the purification agent, and capable of continuously feeding highly pure ammonia.

### DISCLOSURE OF THE INVENTION

The inventors of this invention zealously studied in order to achieve the foregoing object and found that a purification agent of ammonia comprises: a manganese oxide (1), and at least one kind of metal oxide (2) selected from vanadium oxide, chromium oxide, tin oxide, zirconium oxide, bismuth oxide, niobium oxide and tantalum oxide as effective component; wherein a ratio between a number of manganese atom and a number of the entire metallic atoms of the effective component, (Mn/(Mn+V+Cr+Sn+Zr+Bi+Nb+Ta)), is 80 to 99%, extremely improves the removing capability for impurities among crude ammonia, that is, removing amount for impurities per unit amount of the purification agent.

The foregoing purification agent of ammonia was also found to prevent degradation of the removing capability for impurities even after many returns of reproduction of the purification agent, and to extremely elongate the longevity of the purification agent so that a process for purifying ammonia in the present invention was developed.

It was also found that the foregoing purification agent enables to remove a slight amount of impurities such as oxygen, carbon dioxide and moisture to an extremely low concentration, that a combination of the foregoing purification agent and a synthetic zeolite tremendously elongates a purification period before it requires purification in one usage, and that an installment of 2 lines of the purification line provides easy reproduction and shifts of the purification agent with abundant of times. Accordingly, the present invention was completed.

The present invention provides a process for purifying ammonia removing impurities contained in a crude ammonia which comprises contacting the crude ammonia with a purification agent comprises: a manganese oxide, and at least one kind of metal oxide selected from vanadium oxide, chromium oxide, tin oxide, zirconium oxide, bismuth oxide, niobium oxide and tantalum oxide as an effective component; wherein a ratio between a number of manganese atom and a number of the entire metallic atoms of the effective component is 80 to 99%.

Further, the present invention provides a process for purifying ammonia removing impurities contained in a crude ammonia which comprises contacting a crude ammonia with a purification agent comprises: a manganese oxide, and at least one kind of metal oxide selected from vanadium oxide, chromium oxide, stannic oxide, zirconium oxide, bismuth oxide, niobium oxide and tantalum oxide as an effective component; wherein a ratio between a number of manganese atom and a number of the entire metallic atoms of the effective component is 80 to 99%; and further contacting with a synthetic zeolite.

Furthermore, the present invention provides a process for purifying ammonia removing impurities contained in a crude ammonia which comprises contacting a crude ammonia with a purification agent comprises: a manganese oxide, and at least one kind of metal oxide selected from vanadium oxide, chromium oxide, tin oxide, zirconium oxide, bismuth oxide, niobium oxide and tantalum oxide as an effective component; wherein a ratio between a number of manganese atom and a number of the entire metallic atoms of the effective component is 80 to 99%; and further reproducing the purification agent by contacting a reproduction gas with the purification agent.

Still further, the present invention provides a process for purifying ammonia removing impurities contained in a crude ammonia which comprises contacting a crude ammonia with a purification agent comprises: a manganese oxide, and at least one kind of metal oxide selected from vanadium oxide, chromium oxide, tin oxide, zirconium oxide, bismuth oxide, niobium oxide and tantalum oxide as an effective component; wherein a ratio between a number of manganese atom and a number of the entire metallic atoms of the effective component is 80 to 99%; further contacting with a synthetic zeolite; and further reproducing the purification agent and the synthetic zeolite by contacting a reproduction gas with the purification agent and the synthetic zeolite.

### BRIEF DESCRIPTION OF THE DRAWINGS

FIG. 1 is a schematic illustration showing an embodiment of a purification line to carry out a process for purifying ammonia according to the present invention;

FIG. 2 is a schematic illustration showing another embodiment of a purification line to carry out a process for purifying ammonia according to the present invention; and

FIG. 3 is a schematic illustration showing an embodiment of a purification apparatus to carry out a process for purifying ammonia according to the present invention.

### DESCRIPTION OF THE PREFERRED EMBODIMENTS

The present invention is applied to the removal of at least one impurity selected from oxygen, carbon oxide, carbon dioxide and moisture that are contained in ammonia alone or ammonia which has been diluted with hydrogen (hydrogen-based gas) or an inert gas such as nitrogen and argon (inert gas-based gas) [hereinafter referred collectively as “crude ammonia”].

A process for purifying ammonia of the present invention particularly reveals effect in the viewpoint of remarkably elongating longevity of a purification agent employed for purifying ammonia.

The present invention provides a process for purifying ammonia removing impurities contained in a crude ammonia which comprises contacting the crude ammonia with a purification agent comprises: a manganese oxide (1), and at least one kind of metal oxide (2) selected from vanadium oxide, chromium oxide, tin oxide, zirconium oxide, bismuth oxide, niobium oxide and tantalum oxide as an effective component; wherein a ratio (Mn/(Mn+V+Cr+Sn+Zr+Bi+Nb+Ta)) between a number of manganese atom and a number of the entire metallic atoms of the effective component is 80 to 99% and preferably further contacting the crude ammonia with a synthetic zeolite.

Further, the present invention provides a process for purifying ammonia removing impurities contained in a crude ammonia which comprises contacting the crude ammonia with a purification agent comprises: a manganese oxide (1), and at least one kind of metal oxide (2) selected from vanadium oxide, chromium oxide, tin oxide, zirconium oxide, bismuth oxide, niobium oxide and tantalum oxide as an effective component; wherein a ratio (Mn/(Mn+V+Cr+Sn+Zr+Bi+Nb+Ta)) between a number of manganese atom and a number of the entire metallic atoms of the effective component is 80 to 99% and preferably further contacting the crude ammonia with a synthetic zeolite and then, reproducing the purification agent and the synthetic zeolite by contacting a reproduction gas with them.

The manganese oxide employed as the effective component of the purification agent in the present invention is MnO, Mn₃O₄, Mn₂O₃, MnO₂ or the like. In the present invention, its production process does not restrict the manganese oxide, and it has a BET specific surface area preferably in the range of 10 to 500 m²/g. The use of a manganese oxide having a BET specific surface area smaller than 10 m²/g causes a fear of decrease in the amount of removed impurities per unit amount of the purification agent. Conversely, the use thereof having a BET specific surface area larger than 500 m²/g enables efficient removal of impurities, however, the industrial production of it is difficult.

These manganese oxides may be purchased from marketed products for use as such, or may be produced by a well-known process. With regard to the process for producing manganese oxide, MnO is produced, for instance, by heating MnCO₃ or Mn(OH)₂ at the temperature around 500° C. in the absence of oxygen or by reducing higher-grade manganese oxide in a stream of H₂ or CO. Mn₃O₄ is readily produced by igniting a manganese-containing compound (an oxide, hydroxide, sulfite or carbonate thereof) at around 1000° C. in the air or in a stream of oxygen. Mn₂O₃ is produced, for instance, by heating a manganese salt excluding a sulfate thereof at 600 to 800° C. in the air. MnO₂ is produced by stirring and mixing dilute aqueous solution of potassium permanganate, dilute aqueous solution of manganese sulfate and concentrated sulfuric acid under heating, washing the resultant precipitate, and drying the same.

Moreover, in the process for purifying ammonia of the present invention, vanadium oxide, chromium oxide, tin oxide, zirconium oxide, bismuth oxide, niobium oxide, tantalum oxide employed as the effective component of the purification agent aside from manganese oxide is VO, V₂O₃, VO₂, V₂O₅, CrO, Cr₂O₃, CrO₂, Cr₂O₅, CrO₃, SnO, SnO₂, ZrO₂, BiO, Bi₂O₃, Bi₂O₄, Bi₂O₅, NbO, Nb₂O₃, NbO₂, Nb₂O₅, TaO, Ta₂O₃, TaO₂, Ta₂O₅, respectively. Among these metal oxides, it is particularly desirable to employ vanadium oxide, chromium oxide or tin oxide in the viewpoint of elevated capability of removing impurities in crude ammonia. In the present invention, similarly with the manganese oxide, its production process does not restrict the metal oxide, and it has a BET specific surface area preferably in the range of 10 to 500 m²/g. These metal oxides may be purchased from marketed products for use as such, or may be produced by a well-known process.

The purification agent in the process for purifying ammonia of the present invention is prepared so that the ratio (Mn/(Mn+V+Cr+Sn+Zr+Bi+Nb+Ta)) between a number of manganese atom and a number of the entire metallic atoms of the effective component is usually 80 to 99%, preferably 86 to 99%, and more preferably 90 to 98%. When the ratio between a number of manganese atom and a number of the entire metallic atoms of the effective component is smaller than 80% or when the ratio exceeds 99%, not only the capability of removing impurities in crude ammonia decreases but also the purification agent itself degrades in each reproduction process of itself thereby further decreases the capability of removing impurities in crude ammonia. Further, regarding the weight composition of the effective component, the containing ratio of the manganese oxide among the total effective components is preferably 86 to 99% by weight.

The purification agent in the present invention may be usually prepared by mixing aqueous solution including Mn and aqueous solution of sulfuric acid including at least one kind selected from V, Cr, Sn, Zr, Bi, Nb and Ta beforehand, coprecipitating the manganese oxide and the metal oxide of the foregoing metals, filtering the precipitate and further drying, or may be prepared by mixing and palletizing each effective component.

It is preferable in the case of producing the purification agent to add a binder at the time of preparing the same in order to enhance the molding ability and molding strength of the purification agent. The binder is exemplified by alumina sol, silica sol and the like. The amount of the binder, when added, is at most 10% by weight, based on the total weight of the purification agent, preferably at most 5% by weight based thereon. An impurity component other than the effective component such as metals other than the foregoing metals and an oxide thereof may be incorporated in a small amount, however, the content of the effective component is usually at least 70% by weight in the entire purification agents, preferably at least 90% by weight based thereon.

The shape, form and size of the purification agent is not specifically limited. The foregoing purification agent may be spherical, columnar, cylindrical or granular. It has a diameter of approximately 0.5 to 10 mm for spherical form; a diameter of approximately 0.5 to 10 mm and a height of approximately 2 to 20 mm for a columnar form such as pellet and tablet; and a mesh opening of approximately 0.84 to 5.66 mm for irregular form such as granule. The filling density of the purification agent, when filled in a purification column, varies depending upon the shape and preparation method, and is usually 0.4 to 2.0 g/milliliter approximately.

In the process for purifying ammonia according to the present invention, the purification agent comprising a manganese oxide, and at least one kind of metal oxide selected from vanadium oxide, chromium oxide, tin oxide, zirconium oxide, bismuth oxide, niobium oxide and tantalum oxide as an effective component is, prior to use, usually subjected to hydrogen reduction or ammonia reduction for the purpose of activation. The reduction can be put into practice by passing, for instance, a mixed gas of hydrogen and nitrogen or a mixed gas of ammonia and nitrogen at the temperature of 350° C. or lower at superficial linear velocity (LV) of approximately 5 cm/second.

The synthetic zeolite employed for the process for purifying ammonia according to the present invention is, from chemical aspect, the synthetic zeolite, for instance, in which the sodium segment of a hydrated sodium salt of synthetic crystalline aluminosilicate is replaced in part with potassium. The crystalline synthetic zeolite is characterized by its having in the inside of crystals, a large number of pores that are almost uniform in pore size. The synthetic zeolite is usually molded into a spherical form having a mesh size of 4 to 20, a columnar form having a diameter of 1.5 to 4 mm and a height of 5 to 20 mm or the like so that it can be effectively used. It is desirable to employ the synthetic zeolite that has a pore diameter in the range of 3 to 10 Å or equivalent in the process for purifying ammonia of the present invention. Marketed synthetic zeolite that meets the foregoing requirements is exemplified by Molecular Sieves 3A, 4A, 5A and 13X (available from Union Carbide Corporation in U.S.A. or Union Showa Co., Ltd.). Prior to use, the synthetic zeolite is usually activated at the temperature of about 160 to 350° C., in a stream of an inert gas.

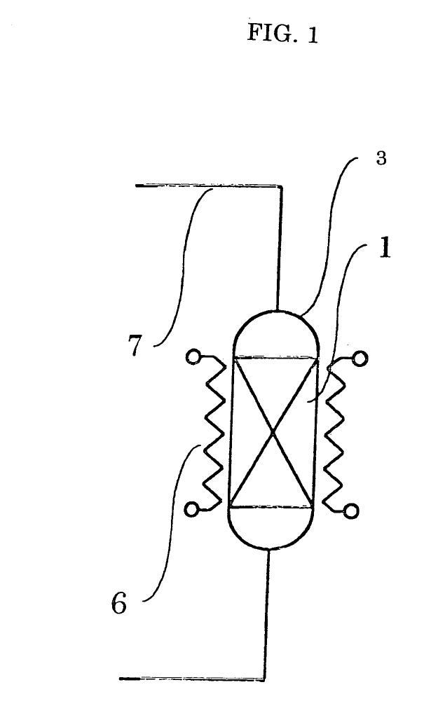

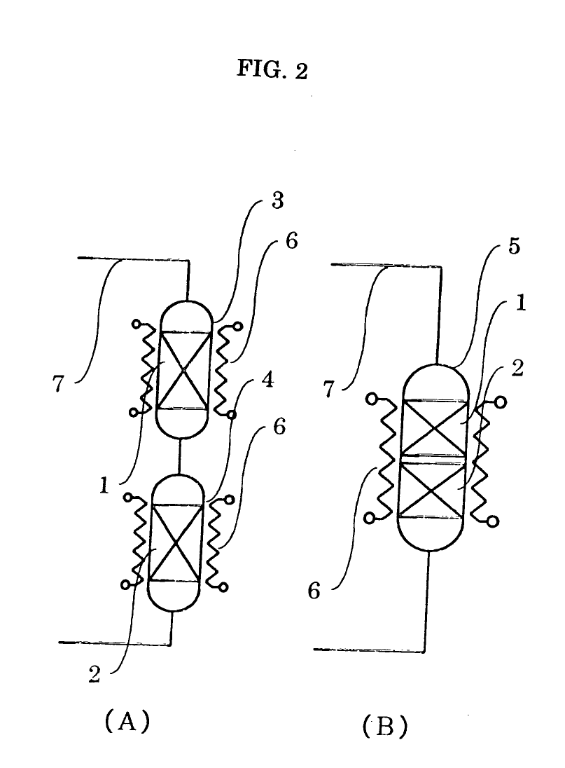

In the case where only the purification agent comprising a manganese oxide, and at least one kind of metal oxide selected from vanadium oxide, chromium oxide, tin oxide, zirconium oxide, bismuth oxide, niobium oxide and tantalum oxide as an effective component is used, the process for purifying ammonia is usually carried out, in a purification line as shown in FIG. 1, after filling the purification agent 1 into purification column 3 and after subjecting reduction treatment, by passing crude ammonia through purification column 3. In the case where both the purification agent and the synthetic zeolite are used, the process for purifying ammonia is usually carried out, either in a purification line as shown in FIG. 2(A), after filling the purification agent 1 into purification column 3 and filling the synthetic zeolite 2 into adsorption column 4 and after subjecting reduction treatment, by passing crude ammonia through purification column 3 and adsorption column 4, or in a purification line as shown in FIG. 2(B), after filling the purification agent 1 and the synthetic zeolite 2 into treatment column 5 and after subjecting reduction treatment, by passing crude ammonia through purification column 5. In FIGS. 1 and 2, numerical symbol 6 indicates a heater and numerical symbol 7 indicates feed line for crude ammonia.

In the process for purifying ammonia according to the present invention, the purification agent principally removes oxygen, carbon monoxide, carbon dioxide and moisture; and the synthetic zeolite principally removes carbon dioxide and moisture. The concentration of these impurities contained in the crude ammonia to which the process according to the present invention is applied is usually 100 ppm or lower.

In general, a filling length of 50 to 1500 mm is applied practically to all of the filling length of the purification agent filled in the purification column, the filling length of the synthetic zeolite filled in the adsorption column or the filling length of the purification agent and the synthetic zeolite filled in the treatment column. A filling length shorter than 50 mm causes a fear of deteriorating the removal ratio of impurities, whereas a filling length longer than 1500 mm causes a fear of excessive pressure loss. The superficial linear velocity (LV) of crude ammonia at the time of ammonia purification varies depending upon the concentration of impurities in ammonia, operational conditions and the like, and thus cannot be unequivocally specified, but it is usually at most 100 cm/second, preferably at most 30 cm/second.

The temperature of contacting ammonia with the purification agent is 150° C. or lower as expressed by the temperature of the gas supplied to the inlet of the purification column, usually is an ordinary temperature without requiring heating or cooling. Similarly, the temperature of contacting ammonia with the synthetic zeolite is usually is an ordinary temperature. The pressure of contacting ammonia with the purification agent or the synthetic zeolite is not specifically restricted. The present process can be put into practice by any of an atmospheric pressure, a reduced pressure such as 1 KPa or an elevated pressure such as 0.5 MPa (absolute pressure), but usually at a pressure between an atmospheric pressure and an elevated pressure of 0.3 MPa (absolute pressure).

In the process for purifying ammonia according to the present invention, a reproduction of the purification agent comprising a manganese oxide, and at least one kind of metal oxide selected from vanadium oxide, chromium oxide, tin oxide, zirconium oxide, bismuth oxide, niobium oxide and tantalum oxide as an effective component is usually carried out by hydrogen reduction or by ammonia reduction. The reduction may be carried out at the temperature of 160 to 400° C. by passing mixed gas of either hydrogen and inert gas of nitrogen, etc., or ammonia and inert gas of nitrogen, etc., however, it is preferable that after supplying the inert gas, feeding hydrogen or ammonia under the foregoing condition in the viewpoint of elongating the longevity of the purification agent. Further, a reproduction of the synthetic zeolite is carried out by passing the inert gas at the temperature of 160 to 350° C.

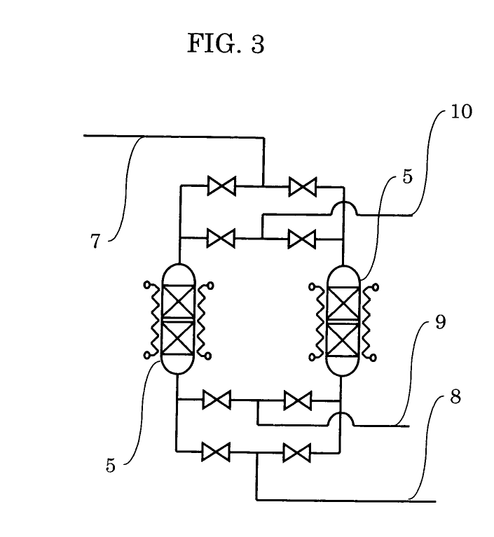

In the process for purifying ammonia according to the present invention, it is preferable that the purification of ammonia is intermittently carried out by deploying at least two lines of either a purification line containing both the purification agent and the synthetic zeolite or a purification line containing only the purification agent in order to easily supplying high purity ammonia continuously. FIG. 3 illustrates an embodiment of a purification apparatus provided for the foregoing application. In FIG. 3, numerical symbol 5 indicates treatment column, numerical symbol 7 indicates feed line for crude ammonia, numerical symbol 8 indicates drawing line for purified ammonia, numerical symbol 9 indicates feed line for reproduction gas, and numerical symbol 10 indicates exhaust line for reproduced exhaust gas. With the use of the purification apparatus, employing one purification line of the foregoing at least two lines in a switched manner repeatedly, feeding and purifying the crude ammonia, the reproduction of the purification agent and synthetic zeolite is made possible by simultaneously feeding the reproduction gas to the line after the purification. Accordingly, the continuous supply of the high purity ammonia may be easily achieved.

### EXAMPLES

In the following examples are described several preferred embodiments to concretely illustrate the invention, however, it is to be understood that the invention is not intended to be limited to the specific embodiments.

### Example 1

(Preparation of Purification Agent)

To an aqueous solution of 395 g of potassium permanganate and 44.0 g of potassium metavanadate in 12.5 kg of water were promptly added a mixed solution of 15.1 kg of aqueous solution of manganese sulfate in 3% by weight concentration and 144 g of concentrated sulfuric acid to proceed with reaction at the temperature of 70° C. The resultant precipitate was agitated at the temperature of 90 CC for 3 hours, filtered, washed with 25 kg of ion exchanged water three times, filtered again to obtain 1250 g of cakey manganese oxide (MnO₂) and vanadium oxide (V₂O₅). The resultant cakey mixed product was dried at the temperature of 90° C. for 12 hours to obtain 380 g of powdery mixed product. The BET specific surface area of the resultant powdery mixed product measured by means of gas adsorption quantity measuring instrument (“Autosorb 3B” produced by Yuasa Ionics Inc.) was 225 m²/g.

To the resultant powdery mixed product in an amount of 100 g were added under kneading 2 g of alumina sol and 40 g of water to obtain a cake, which was extruded with an extruder to obtain a molded product having a diameter of 1.6 mm. The resultant molded product was cut into pieces of about 10 mm in length to obtain pellets. The resultant pellets were dried at the temperature of 120° C. for 12 hours to obtain purification agent. The ratio between a number of manganese atoms and a number of the entire metallic atoms of the effective component (manganese oxide and vanadium oxide) among the resultant purification agent was 94% and the moisture content among the purification agent was 0.8% by weight.

(Purification Test of Ammonia)

The foregoing purification agent was filled in a stainless steel-made purification column having an inside diameter of 45.2 mm and a length of 200 mm so that the filling length was made to be 150 mm. Subsequently, the temperature of the purification agent was raised to 250° C., a mixed gas of hydrogen and nitrogen (5% by volume of hydrogen and 95% by volume of nitrogen) was passed therethrough for 5 hours under atmospheric pressure and at a flow rate of 2887 milliliter/minute (LV of 3.0 cm/second) to effect reduction treatment of the purification agent, and thereafter the purification agent was cooled down to ordinary temperature.

Consecutively, ammonia purification was put into practice by passing crude ammonia containing 50 ppm of oxygen as impurities through the purification column at ordinary temperature (20° C.) with a flow rate of 9622 milliliter/minute (LV of 10 cm/second). Measurements were made of the concentrations of oxygen in the outlet treated gas by means of a heat transmission detector (GC-TCD, detectable lower limit concentration of 0.2 ppm) at intervals of about 20 minutes until oxygen was detected. The amount (milliliter) of oxygen removal per 1 g of the purification agent was obtained by the foregoing procedure. The results are described in Table 1.

After the detection of oxygen, feeding of crude ammonia was discontinued and the temperature of the purification agent was raised to 250° C. Then, reproduction of the purification agent was put into practice by passing nitrogen under atmospheric pressure with a flow rate of 2887 milliliter/minute (LV of 3.0 cm/second) for 1 hour and further passing mixed gas of hydrogen and nitrogen (5% by volume of hydrogen and 95% by volume of nitrogen) under atmospheric pressure with flow rate of 2887 milliliter/minute (LV of 3.0 cm/second) for 5 hours. Consecutively, the purification agent was cooled down to the ordinary temperature, and thereafter, ammonia purification was started again. The foregoing procedures were carried out repeatedly, and the amount (milliliter) of oxygen removal per 1 g of the purification agent was obtained in each procedure. The results are described in Table 1.

### Example 2 and Example 3

Purification agent were prepared in the same manner as Example 1 except that the ratio between a number of manganese atom and a number of the entire metallic atoms of the effective component among the resultant purification agent was changed to 97% or 88% respectively in Example 2 or Example 3.

Ammonia purification tests were carried out in the same manner as Example 1 except that the foregoing purification agents were employed in Example 2 and Example 3. The results are described in Table 1.

### Example 4

Ammonia purification test was carried out in the same manner as Example 1 except that crude ammonia containing 50 ppm of carbon dioxide as impurities was employed as the crude ammonia in Example 4. The results are described in Table 1. Carbon dioxide was analyzed by means of a hydrogen flame ionization detector (GC-FID with metanizer, detectable limit concentration of 0.5 ppm) in Example 4. Analysis of carbon dioxides in Examples or Comparative Examples below was done in accordance with the above-mentioned approach.

### Example 5 and Example 6

Purification agent were prepared in the same manner as Example 1 except that the ratio between a number of manganese atom and a number of the entire metallic atoms of the effective component among the resultant purification agent was changed to 97% or 88% respectively in Example 5 or Example 6.

Ammonia purification tests were carried out in the same manner as Example 4 except that the foregoing purification agents were employed in Example 5 and Example 6. The results are described in Table 1.

### Example 7

Ammonia purification test was carried out in the same manner as Example 1 except that crude ammonia containing 50 ppm of moisture as impurities was employed as the crude ammonia in Example 7. The results are described in Table 1. Moisture was analyzed by means of a Fourier transformation infrared spectrophotometer (FI-IR, detectable lower limit concentration of 0.05 ppm) in Example 7. Analysis of moistures in Examples or Comparative Examples below was done in accordance with the above-mentioned approach.

### Example 8 and Example 9

Purification agent were prepared in the same manner as Example 1 except that the ratio between a number of manganese atom and a number of the entire metallic atoms of the effective component among the resultant purification agent was changed to 97% or 88% respectively in Example 8 or Example 9.

Ammonia purification tests were carried out in the same manner as Example 7 except that the foregoing purification agents were employed in Example 8 and Example 9. The results are described in Table 1.

TABLE 1
Purification Agent: Manganese Oxide, Vanadium Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 1 | 94% | O₂ | 12.4 | 10.6 | 10.1 | 9.7 | 9.3 |
| Ex. 2 | 97% | O₂ | 11.5 | 9.9 | 9.4 | 9.3 | 8.9 |
| Ex. 3 | 88% | O₂ | 12.0 | 10.1 | 9.8 | 9.5 | 9.0 |
| Ex. 4 | 94% | CO₂ | 9.6 | 8.7 | 8.4 | 8.2 | 8.1 |
| Ex. 5 | 97% | CO₂ | 9.3 | 8.9 | 8.7 | 8.5 | 8.2 |
| Ex. 6 | 88% | CO₂ | 9.1 | 8.4 | 8.1 | 7.9 | 7.6 |
| Ex. 7 | 94% | H₂O | 3.4 | 2.9 | 2.7 | 2.7 | 2.5 |
| Ex. 8 | 97% | H₂O | 3.3 | 2.7 | 2.6 | 2.5 | 2.4 |
| Ex. 9 | 88% | H₂O | 3.4 | 2.8 | 2.6 | 2.5 | 2.3 |

### Example 10

(Preparation of Purification Agent)

To an aqueous solution of 395 g of potassium permanganate and 61.9 g of potassium chromate in 12.5 kg of water were promptly added a mixed solution of 15.1 kg of aqueous solution of manganese sulfate in 3% by weight concentration and 144 g of concentrated sulfuric acid to proceed with reaction at the temperature of 70° C. The resultant precipitate was agitated at the temperature of 90° C. for 3 hours, filtered, washed with 25 kg of ion exchanged water three times, filtered again to obtain 1240 g of cakey manganese oxide (MnO₂) and chromium oxide (CrO₃). The resultant cakey mixed product was dried at the temperature of 90° C. for 12 hours to obtain 370 g of powdery mixed product. The BET specific surface area of the resultant powdery mixed product measured by means of gas adsorption quantity measuring instrument (“Autosorb 3B” produced by Yuasa Ionics Inc.) was 220 m₂/g.

To the resultant powdery mixed product in an amount of 100 g were added under kneading 2 g of alumina sol and 40 g of water to obtain a cake, which was extruded with an extruder to obtain a molded product having a diameter of 1.6 mm. The resultant molded product was cut into pieces of about 10 mm in length to obtain pellets. The resultant pellets were dried at the temperature of 120° C. for 12 hours to obtain purification agent. The ratio between a number of manganese atoms and a number of the entire metallic atoms of the effective component (manganese oxide and chromium oxide) among the resultant purification agent was 94% and the moisture content among the purification agent was 0.7% by weight.

(Purification Test of Ammonia)

Ammonia purification test was carried out in the same manner as Example 1 except that the foregoing purification agent containing manganese oxide and chromium oxide as the effective component was employed in Example 10. The results are described in Table 2.

### Example 11 and Example 12

Purification agent were prepared in the same manner as Example 10 except that the ratio between a number of manganese atom and a number of the entire metallic atoms of the effective component among the resultant purification agent was changed to 97% or 88% respectively in Example 11 or Example 12.

Ammonia purification tests were carried out in the same manner as Example 10 except that the foregoing purification agents were employed in Example 11 and Example 12. The results are described in Table 2.

### Example 13

Ammonia purification test was carried out in the same manner as Example 10 except that crude ammonia containing 50 ppm of carbon dioxide as impurities was employed as the crude ammonia in Example 13. The results are described in Table 2.

### Example 14 and Example 15

Purification agent were prepared in the same manner as Example 10 except that the ratio between a number of manganese atom and a number of the entire metallic atoms of the effective component among the resultant purification agent was changed to 97% or 88% respectively in Example 14 or Example 15.

Ammonia purification tests were carried out in the same manner as Example 13 except that the foregoing purification agents were employed in Example 14 and Example 15. The results are described in Table 2.

### Example 16

Ammonia purification test was carried out in the same manner as Example 10 except that crude ammonia containing 50 ppm of moisture as impurities was employed as the crude ammonia in Example 16. The results are described in Table 2.

### Example 17 and Example 18

Purification agent were prepared in the same manner as Example 10 except that the ratio between a number of manganese atom and a number of the entire metallic atoms of the effective component among the resultant purification agent was changed to 97% or 88% respectively in Example 17 or Example 18.

Ammonia purification tests were carried out in the same manner as Example 16 except that the foregoing purification agents were employed in Example 17 and Example 18. The results are described in Table 2.

TABLE 2
Purification Agent: Manganese Oxide, Chromium Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 10 | 94% | O₂ | 15.1 | 13.5 | 13.6 | 13.2 | 12.9 |
| Ex. 11 | 97% | O₂ | 14.3 | 12.1 | 11.9 | 11.8 | 11.5 |
| Ex. 12 | 88% | O₂ | 14.6 | 12.2 | 12.0 | 11.7 | 11.6 |
| Ex. 13 | 94% | CO₂ | 13.6 | 11.6 | 11.5 | 11.4 | 11.2 |
| Ex. 14 | 97% | CO₂ | 13.4 | 10.5 | 10.6 | 10.3 | 10.1 |
| Ex. 15 | 88% | CO₂ | 13.1 | 10.8 | 10.7 | 10.5 | 10.3 |
| Ex. 16 | 94% | H₂O | 5.2 | 4.8 | 4.6 | 4.7 | 4.5 |
| Ex. 17 | 97% | H₂O | 4.7 | 4.0 | 4.1 | 4.1 | 3.6 |
| Ex. 18 | 88% | H₂O | 5.1 | 4.4 | 4.6 | 4.3 | 4.2 |

### Examples 19 to 21

Purification agent containing manganese oxide and tin oxide as an effective component and of which the ratio between a number of manganese atom and a number of the entire metallic atoms of the effective component among the resultant purification agent was 88%, 94% or 97% respectively was prepared in Examples 19 to 21 in a similar manner as Example 1.

Ammonia purification tests were carried out in the same manner as Example 1 except that the foregoing purification agents were employed in Examples 19 to 21. The results are described in Table 3.

### Examples 22 to 24

Ammonia purification test was carried out in the same manner as Examples 19 to 21 except that crude ammonia containing 50 ppm of carbon dioxide as impurities was employed as the crude ammonia in Examples 22 to 24. The results are described in Table 3.

### Examples 25 to 27

Ammonia purification test was carried out in the same manner as Examples 19 to 21 except that crude ammonia containing 50 ppm of moisture as impurities was employed as the crude ammonia in Examples 25 to 27. The results are described in Table 3.

TABLE 3
Purification Agent: Manganese Oxide, Tin Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 19 | 94% | O₂ | 13.2 | 11.5 | 11.2 | 11.0 | 10.9 |
| Ex. 20 | 97% | O₂ | 12.9 | 10.8 | 10.9 | 10.8 | 10.3 |
| Ex. 21 | 88% | O₂ | 12.7 | 10.2 | 10.1 | 9.6 | 9.7 |
| Ex. 22 | 94% | CO₂ | 10.4 | 9.6 | 9.5 | 9.3 | 9.2 |
| Ex. 23 | 97% | CO₂ | 10.5 | 9.8 | 9.4 | 9.2 | 8.9 |
| Ex. 24] | 88% | CO₂ | 10.3 | 9.4 | 9.1 | 8.9 | 8.8 |
| Ex. 25 | 94% | H₂O | 4.3 | 3.6 | 3.4 | 3.2 | 2.9 |
| Ex. 26 | 97% | H₂O | 4.1 | 3.8 | 3.5 | 3.4 | 3.1 |
| Ex. 27 | 88% | H₂O | 4.2 | 3.4 | 3.2 | 3.2 | 3.0 |

### Examples 28 to 30

Purification agent containing manganese oxide and zirconium oxide as an effective component and of which the ratio between a number of manganese atom and a number of the entire metallic atoms of the effective component among the resultant purification agent was 88%, 94% or 97% respectively was prepared in Examples 28 to 30 in a similar manner as Example 1. Ammonia purification tests were carried out in the same manner as Example 1 except that the foregoing purification agents were employed in Examples 28 to 30. The results are described in Table 4.

TABLE 4
Purification Agent: Manganese Oxide, Zirconium Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 28 | 94% | O₂ | 10.3 | 9.7 | 9.5 | 8.9 | 8.2 |
| Ex. 29 | 97% | O₂ | 9.6 | 8.9 | 8.6 | 8.1 | 7.8 |
| Ex. 30 | 88% | O₂ | 9.8 | 8.7 | 8.5 | 8.1 | 7.6 |

### Examples 31 to 33

Purification agent containing manganese oxide and bismuth oxide as an effective component and of which the ratio between a number of manganese atom and a number of the entire metallic atoms of the effective component among the resultant purification agent was 88%, 94% or 97% respectively was prepared in Examples 31 to 33 in a similar manner as Example 1. Ammonia purification tests were carried out in the same manner as Example 1 except that the foregoing purification agents were employed in Examples 31 to 33. The results are described in Table

TABLE 5
Purification Agent: Manganese Oxide, Bismuth Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 31 | 94% | O₂ | 10.4 | 9.6 | 9.3 | 9.1 | 8.6 |
| Ex. 32 | 97% | O₂ | 9.8 | 9.1 | 9.0 | 8.8 | 8.5 |
| Ex. 33 | 88% | O₂ | 9.2 | 8.6 | 8.5 | 8.4 | 8.3 |

### Examples 34 to 36

Purification agent containing manganese oxide and niobium oxide as an effective component and of which the ratio between a number of manganese atom and a number of the entire metallic atoms of the effective component among the resultant purification agent was 88%, 94% or 97% respectively was prepared in Examples 34 to 36 in a similar manner as Example 1. Ammonia purification tests were carried out in the same manner as Example 1 except that the foregoing purification agents were employed in Examples 34 to 36. The results are described in Table 6.

TABLE 6
Purification Agent: Manganese Oxide, Niobium Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 34 | 94% | O₂ | 5.6 | 5.1 | 4.9 | 4.7 | 4.5 |
| Ex. 35 | 97% | O₂ | 5.8 | 5.4 | 5.3 | 4.9 | 4.4 |
| Ex. 36 | 88% | O₂ | 5.3 | 4.9 | 4.9 | 4.5 | 4.1 |

### Examples 37 to 39

Purification agent containing manganese oxide and tantalum oxide as an effective component and of which the ratio between a number of manganese atom and a number of the entire metallic atoms of the effective component among the resultant purification agent was 88%, 94% or 97% respectively was prepared in Examples 37 to 39 in a similar manner as Example 1. Ammonia purification tests were carried out in the same manner as Example 1 except that the foregoing purification agents were employed in Examples 37 to 39. The results are described in Table 7.

TABLE 7
Purification Agent: Manganese Oxide, Tantalum Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 37 | 94% | O₂ | 6.1 | 5.7 | 5.4 | 5.3 | 4.9 |
| Ex. 38 | 97% | O₂ | 6.0 | 5.7 | 5.3 | 5.1 | 4.9 |
| Ex. 39 | 88% | O₂ | 5.9 | 5.5 | 5.1 | 4.9 | 4.6 |

### Examples 40 to 42

Purification agent containing manganese oxide, vanadium oxide and chromium oxide as an effective component and of which the ratio between a number of manganese atom and a number of the entire metallic atoms of the effective component among the resultant purification agent was 88%, 94% or 97% respectively was prepared in Examples 40 to 42 in a similar manner as Example 1. The numbers of vanadium atoms and chromium atoms were equal. Ammonia purification tests were carried out in the same manner as Example 1 except that the foregoing purification agents were employed in Examples 40 to 42. The results are described in Table 8.

TABLE 8
Purification Agent: Manganese Oxide, Vanadium Oxide,
Chromium Oxide

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 40 | 94% | O₂ | 14.2 | 13.1 | 12.9 | 12.5 | 11.5 |
| Ex. 41 | 97% | O₂ | 13.9 | 11.8 | 11.7 | 11.2 | 10.8 |
| Ex. 42 | 88% | O₂ | 13.7 | 11.6 | 11.1 | 10.9 | 10.7 |

### Example 43

(Purification of Ammonia)

The purification agent employed in Example 10 was filled in a stainless steel-made treatment column having an inside diameter of 45.2 mm and a length of 400 mm so that the filling length was made to be 150 mm. Further, marketed synthetic zeolite having a pore diameter of 4 Å or equivalent (Molecular Sieves 4A, available from Union Carbide Corporation) was filled in the downstream of the purification agent so that the filling length was made to be 150 mm. Subsequently, the temperature of the purification agent was raised to 250° C., a mixed gas of hydrogen and nitrogen (5% by volume of hydrogen and 95% by volume of nitrogen) was passed from side of the synthetic zeolite therethrough for 5 hours under atmospheric pressure and at a flow rate of 2887 milliliter/minute (LV of 3.0 cm/second) to effect reduction treatment of the purification agent, and thereafter the purification agent was cooled down to ordinary temperature. Further, the temperature of the synthetic zeolite was raised to 350° C., a nitrogen gas was passed from side of the purification agent therethrough for 4 hours under atmospheric pressure and at a flow rate of 2887 milliliter/minute (LV of 3.0 cm/second) to effect activation treatment of the synthetic zeolite, and thereafter the synthetic zeolite was cooled down to ordinary temperature.

Consecutively, ammonia containing 50 ppm of oxygen as impurities was passed through the treatment column at ordinary temperature (20° C.) with a flow rate of 9622 milliliter/minute (LV of 10 cm/second) to carry out ammonia purification. Measurements were made of the concentrations of oxygen in the outlet treated gas by means of a heat transmission detector (GC-TCD, detectable lower limit concentration of 0.2 ppm) at intervals of about 20 minutes until oxygen was detected. The amount (milliliter) of oxygen removal per 1 g of the purification agent and the synthetic zeolite was obtained by the foregoing procedure. The results are described in Table 9.

After the detection of oxygen, feeding of crude ammonia was discontinued and the temperature of the purification agent was raised to 250° C. Then, reproduction of the purification agent was put into practice by passing nitrogen from the side of the synthetic zeolite under atmospheric pressure with a flow rate of 2887 milliliter/minute (LV of 3.0 cm/second) for 1 hour and further passing mixed gas of hydrogen and nitrogen (5% by volume of hydrogen and 95% by volume of nitrogen) under atmospheric pressure with flow rate of 2887 milliliter/minute (LV of 3.0 cm/second) for 5 hours. Consecutively, the purification agent was cooled down to the ordinary temperature. Further, the temperature of the synthetic zeolite was raised to 350° C., a nitrogen gas was passed from side of the purification agent therethrough for 4 hours under atmospheric pressure and at a flow rate of 2887 milliliter/minute (LV of 3.0 cm/second) to effect reproduction of the synthetic zeolite. Consecutively, the synthetic zeolite was cooled down to the ordinary temperature, and thereafter, ammonia purification was started again. The foregoing procedures were carried out repeatedly, and the amount (milliliter) of oxygen removal per 1 g of the purification agent and the synthetic zeolite was obtained in each procedure. The results are described in Table 9.

### Example 44 and Example 45

Purification agent were prepared in the same manner as Example 10 except that the ratio between a number of manganese atom and a number of the entire metallic atoms of the effective component among the resultant purification agent was changed to 97% or 88% respectively in Example 44 or Example 45. Ammonia purification tests were carried out in the same manner as Example 43 except that the foregoing purification agents were employed in Example 44 and Example 45. The results are described in Table 9.

### Examples 46 to 48

Ammonia purification test was carried out in the same manner as Examples 43 to 45 except that crude ammonia containing 50 ppm of carbon dioxide as impurities was employed as the crude ammonia in Examples 46 to 48. The results are described in Table 9.

### Examples 49 to 51

Ammonia purification test was carried out in the same manner as Examples 43 to 45 except that crude ammonia containing 50 ppm of moisture as impurities was employed as the crude ammonia in Examples 49 to 51. The results are described in Table 9.

TABLE 9
Purification Agent: Manganese Oxide, Chromium Oxide
and Synthetic Zeolite

| | | | Removed Amount by Purification | | | | |
|---|---|---|---|---|---|---|---|
| | Ratio of | | Agent (ml/g) | | | | |
| | Mn atom | Impurities | First | Second | Third | Fifth | Tenth |
| Ex. 43 | 94% | O₂ | 8.9 | 8.5 | 8.4 | 8.3 | 8.1 |
| Ex. 44 | 97% | O₂ | 8.4 | 7.9 | 7.8 | 7.8 | 7.7 |
| Ex. 45 | 88% | O₂ | 8.6 | 7.8 | 7.8 | 7.7 | 7.5 |
| Ex. 46 | 94% | CO₂ | 8.5 | 8.2 | 8.1 | 7.9 | 7.8 |
| Ex. 47 | 97% | CO₂ | 8.7 | 8.5 | 8.2 | 8.0 | 7.8 |
| Ex. 48 | 88% | CO₂ | 7.9 | 7.7 | 7.6 | 7.6 | 7.3 |
| Ex. 49 | 94% | H₂O | 27.5 | 23.6 | 22.9 | 20.6 | 19.5 |
| Ex. 50 | 97% | H₂O | 23.2 | 21.0 | 20.3 | 19.8 | 18.0 |
| Ex. 51 | 88% | H₂O | 24.6 | 20.9 | 20.2 | 19.3 | 18.1 |

### Comparative Examples 1 to 12

Purification agent containing manganese oxide and vanadium oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Examples 1, 4 and 7 except that the foregoing purification agents were employed in Comparative Examples 1 to 12. The results are described in Table 10.

TABLE 10
Purification Agent: Manganese Oxide, Vanadium Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 1 | 20% | O₂ | less than 1 | less than 1 | less than 1 | less than 1 | less than 1 |
| Com. Ex. 2 | 50% | O₂ | 1.6 | 1.3 | 1.1 | less than 1 | less than 1 |
| Com. Ex. 3 | 75% | O₂ | 3.5 | 2.4 | 2.1 | 1.8 | 1.4 |
| Com. Ex. 4 | 99.5% | O₂ | 1.2 | 1.0 | less than 1 | less than 1 | less than 1 |
| Com. Ex. 5 | 20% | CO₂ | less than 1 | less than 1 | less than 1 | less than 1 | less than 1 |
| Com. Ex. 6 | 50% | CO₂ | 1.3 | less than 1 | less than 1 | less than 1 | less than 1 |
| Com. Ex. 7 | 75% | CO₂ | 4.4 | 3.5 | 3.3 | 3.1 | 2.8 |
| Com. Ex. 8 | 99.5% | CO₂ | 1.1 | less than 1 | less than 1 | less than 1 | less than 1 |
| Com. Ex. 9 | 20% | H₂O | less than 1 | less than 1 | less than 1 | less than 1 | less than 1 |
| Com. Ex. 10 | 50% | H₂O | less than 1 | less than 1 | less than 1 | less than 1 | less than 1 |
| Com. Ex. 11 | 75% | H₂O | 1.3 | less than 1 | less than 1 | less than 1 | less than 1 |
| Com. Ex. 12 | 99.5% | H₂O | 1.2 | less than 1 | less than 1 | less than 1 | less than 1 |

### Comparative Examples 13 to 24

Purification agent containing manganese oxide and chromium oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Examples 10, 13 and 16 except that the foregoing purification agents were employed in Comparative Examples 13 to 24. The results are described in Table 11.

TABLE 11
Purification Agent: Manganese Oxide, Chromium Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 13 | 20% | O₂ | 1.5 | 1.2 | less than 1 | less than 1 | less than 1 |
| Com. Ex. 14 | 50% | O₂ | 3.1 | 2.1 | 1.8 | 1.4 | 1.1 |
| Com. Ex. 15 | 75% | O₂ | 5.2 | 4.3 | 3.9 | 3.8 | 3.6 |
| Com. Ex. 16 | 99.5% | O₂ | 6.4 | 3.5 | 3.2 | 3.1 | 2.9 |
| Com. Ex. 17 | 20% | CO₂ | 1.5 | 1.2 | less than 1 | less than 1 | less than 1 |
| Com. Ex. 18 | 50% | CO₂ | 2.9 | 2.1 | 1.8 | 1.6 | 1.5 |
| Com. Ex. 19 | 75% | CO₂ | 4.4 | 3.9 | 3.6 | 3.4 | 3.3 |
| Com. Ex. 20 | 99.5% | CO₂ | 2.2 | 1.9 | 1.8 | 1.7 | 1.5 |
| Com. Ex. 21 | 20% | H₂O | less than 1 | less than 1 | less than 1 | less than 1 | less than 1 |
| Com. Ex. 22 | 50% | H₂O | less than 1 | less than 1 | less than 1 | less than 1 | less than 1 |
| Com. Ex. 23 | 75% | H₂O | 1.6 | 1.2 | 1.1 | less than 1 | less than 1 |
| Com. Ex. 24 | 99.5% | H₂O | 1.3 | 1.1 | 1.1 | less than 1 | less than 1 |

### Comparative Examples 25 to 36

Purification agent containing manganese oxide and tin oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Examples 19, 22 and 25 except that the foregoing purification agents were employed in Comparative Examples 25 to 36. The results are described in Table 12.

TABLE 12
Purification Agent: Manganese Oxide, Tin Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 25 | 20% | O₂ | less than 1 | less than 1 | less than 1 | less than 1 | less than 1 |
| Com. Ex. 26 | 50% | O₂ | 1.2 | less than 1 | less than 1 | less than 1 | less than 1 |
| Com. Ex. 27 | 75% | O₂ | 1.9 | 1.1 | less than 1 | less than 1 | less than 1 |
| Com. Ex. 28 | 99.5% | O₂ | less than 1 | less than 1 | less than 1 | less than 1 | less than 1 |
| Com. Ex. 29 | 20% | CO₂ | less than 1 | less than 1 | less than 1 | less than 1 | less than 1 |
| Com. Ex. 30 | 50% | CO₂ | 1.3 | less than 1 | less than 1 | less than 1 | less than 1 |
| Com. Ex. 31 | 75% | CO₂ | 4.4 | 3.5 | 3.3 | 3.1 | 2.8 |
| Com. Ex. 32 | 99.5% | CO₂ | 1.1 | less than 1 | less than 1 | less than 1 | less than 1 |
| Com. Ex. 33 | 20% | H₂O | less than 1 | less than 1 | less than 1 | less than 1 | less than 1 |
| Com. Ex. 34 | 50% | H₂O | less than 1 | less than 1 | less than 1 | less than 1 | less than 1 |
| Com. Ex. 35 | 75% | H₂O | 1.6 | 1.2 | less than 1 | less than 1 | less than 1 |
| Com. Ex. 36 | 99.5% | H₂O | 1.8 | 1.2 | less than 1 | less than 1 | less than 1 |

### Comparative Examples 37 to 40

Purification agent containing manganese oxide and zirconium oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Example 28 except that the foregoing purification agents were employed in Comparative Examples 37 to 40. The results are described in Table 13.

TABLE 13
Purification Agent: Manganese Oxide, Zirconium Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 37 | 20% | O₂ | 1.1 | less than 1 | less than 1 | less than 1 | less than 1 |
| Com. Ex. 38 | 50% | O₂ | 1.9 | 1.7 | 1.6 | 1.4 | 1.2 |
| Com. Ex. 39 | 75% | O₂ | 2.3 | 1.8 | 1.7 | 1.6 | 1.6 |
| Com. Ex. 40 | 99.5% | O₂ | 2.6 | 2.1 | 1.9 | 1.8 | 1.6 |

### Comparative Examples 41 to 44

Purification agent containing manganese oxide and bismuth oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Example 31 except that the foregoing purification agents were employed in Comparative Examples 41 to 44. The results are described in Table 14.

TABLE 14
Purification Agent: Manganese Oxide, Bismuth Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 41 | 20% | O₂ | 1.3 | less than 1 | less than 1 | less than 1 | less than 1 |
| Com. Ex. 42 | 50% | O₂ | 1.6 | 1.2 | less than 1 | less than 1 | less than 1 |
| Com. Ex. 43 | 75% | O₂ | 3.1 | 2.7 | 2.5 | 2.4 | 2.2 |
| Com. Ex. 44 | 99.5% | O₂ | 2.5 | 2.0 | 1.9 | 1.8 | 1.7 |

### Comparative Examples 45 to 48

Purification agent containing manganese oxide and niobium oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Example 34 except that the foregoing purification agents were employed in Comparative Examples 45 to 48. The results are described in Table 15.

TABL 15
Purification Agent: Manganese Oxide, Niobium Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 45 | | O₂ | less than 1 | less than 1 | less than 1 | less than 1 | less than 1 |
| Com. Ex. 46 | 50% | O₂ | less than 1 | less than 1 | less than 1 | less than 1 | less than 1 |
| Com. Ex. 47 | 75% | O₂ | 2.3 | 1.9 | 1.8 | 1.5 | 1.3 |
| Com. Ex. 48 | 99.5% | O₂ | 1.5 | 1.2 | 1.1 | 1.0 | less than 1 |

### Comparative Examples 49 to 52

Purification agent containing manganese oxide and tantalum oxide as an effective component and of which the ratio between a number of manganese atom and a number of the entire metallic atoms of the effective component among the resultant purification agent was 20%, 50%, 75% or 99.5% respectively was prepared in Comparative Examples in a similar manner as Example 1.

Ammonia purification tests were carried out in the same manner as Example 37 except that the foregoing purification agents were employed in Comparative Examples 49 to 52. The results are described in Table 16.

TABLE 16
Purification Agent: Manganese Oxide, Tantalum Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 49 | 20% | O₂ | less than 1 | less than 1 | less than 1 | less than 1 | less than 1 |
| Com. Ex. 50 | 50% | O₂ | 1.1 | less than 1 | less than 1 | less than 1 | less than 1 |
| Com. Ex. 51 | 75% | O₂ | 2.1 | 1.4 | 1.3 | 1.3 | 1.1 |
| Com. Ex. 52 | 99.5% | O₂ | 1.6 | 1.1 | less than 1 | less than 1 | less than 1 |

### Comparative Examples 53 to 64

Purification agent containing manganese oxide and iron oxide as an effective component and of which the ratio between a number of manganese atom and a number of the entire metallic atoms of the effective component among the resultant purification agent was 88%, 94%, 97% or 100% respectively was prepared in Comparative Examples in a similar manner as Example 1. Ammonia purification tests were carried out in the same manner as Examples 1, 4 and 7 except that the foregoing purification agents were employed in Comparative Examples 53 to 64. The results are described in Table 17.

TABLE 17
Purification Agent: Manganese Oxide, Iron Oxide

| | Ratio of | | Removed Amount by Purification Agent (ml/g) | | | | |
|---|---|---|---|---|---|---|---|
| | Mn atom | Impurities | First | Second | Third | Fifth | Tenth |
| Com. Ex. 53 | 94% | O₂ | 2.4 | less than 1 | less than 1 | less than 1 | less than 1 |
| Com. Ex. 54 | 97% | O₂ | 2.3 | less than 1 | less than 1 | less than 1 | less than 1 |
| Com. Ex. 55 | 88% | O₂ | 2.5 | less than 1 | less than 1 | less than 1 | less than 1 |
| Com. Ex. 56 | 100% | O₂ | 1.4 | less than 1 | less than 1 | less than 1 | less than 1 |
| Com. Ex. 57 | 94% | CO₂ | 2.2 | less than 1 | less than 1 | less than 1 | less than 1 |
| Com. Ex. 58 | 97% | CO₂ | 1.9 | less than 1 | less than 1 | less than 1 | less than 1 |
| Com. Ex. 59 | 88% | CO₂ | 2.3 | less than 1 | less than 1 | less than 1 | less than 1 |
| Com. Ex. 60 | 100% | CO₂ | 1.3 | less than 1 | less than 1 | less than 1 | less than 1 |
| Com. Ex. 61 | 94% | H₂O | 1.5 | less than 1 | less than 1 | less than 1 | less than 1 |
| Com. Ex. 62 | 97% | H₂O | 1.4 | less than 1 | less than 1 | less than 1 | less than 1 |
| Com. Ex. 63 | 88% | H₂O | 1.4 | less than 1 | less than 1 | less than 1 | less than 1 |
| Com. Ex. 64 | 100% | H₂O | 1.3 | less than 1 | less than 1 | less than 1 | less than 1 |

According to the process for purifying ammonia of the present invention, a slight amount of impurities such as oxygen, carbon monoxide, carbon dioxide and moisture contained in crude ammonia was became to be removable to an extent extremely great amount as compared with the conventional purification process under a converted removed amount per unit amount of the purification agent. Additionally, any repeated reproduction of the purification agent does not reduce the capability of removing impurities in crude ammonia, and the longevity of the purification agent was remarkably elongated than the conventional purification process.

What is claimed is:

1. A process for purifying ammonia removing impurities contained in a crude ammonia which comprises contacting the crude ammonia with a purification agent comprises: a manganese oxide, and at least one kind of metal oxide selected from vanadium oxide, chromium oxide, tin oxide, zirconium oxide, bismuth oxide, niobium oxide and tantalum oxide as an effective component; wherein a ratio between a number of manganese atom and a number of the entire metallic atoms of the effective component is 80 to 99%.

2. A process for purifying ammonia removing impurities contained in a crude ammonia which comprises contacting a crude ammonia with a purification agent comprises: a manganese oxide, and at least one kind of metal oxide selected from vanadium oxide, chromium oxide, stannic oxide, zirconium oxide, bismuth oxide, niobium oxide and tantalum oxide as an effective component; wherein a ratio between a number of manganese atom and a number of the entire metallic atoms of the effective component is 80 to 99%; and further contacting with a synthetic zeolite.

3. A process for purifying ammonia removing impurities contained in a crude ammonia which comprises contacting a crude ammonia with a purification agent comprises: a manganese oxide, and at least one kind of metal oxide selected from vanadium oxide, chromium oxide, tin oxide, zirconium oxide, bismuth oxide, niobium oxide and tantalum oxide as an effective component; wherein a ratio between a number of manganese atom and a number of the entire metallic atoms of the effective component is 80 to 99%; and further reproducing the purification agent by contacting a reproduction gas with the purification agent.

4. A process for purifying ammonia removing impurities contained in a crude ammonia which comprises contacting a crude ammonia with a purification agent comprises: a manganese oxide, and at least one kind of metal oxide selected from vanadium oxide, chromium oxide, tin oxide, zirconium oxide, bismuth oxide, niobium oxide and tantalum oxide as an effective component; wherein a ratio between a number of manganese atom and a number of the entire metallic atoms of the effective component is 80 to 99%; further contacting with a synthetic zeolite; and further reproducing the purification agent and the synthetic zeolite by contacting a reproduction gas with the purification agent and the synthetic zeolite.

5. The process for purifying ammonia according to any one of claims 1 to 4, wherein the content of said effective component is usually at least 70% by weight in the entire purification agent.

6. The process for purifying ammonia according to any one of claims 1 to 4, wherein said manganese oxide is MnO, Mn₃O₄, Mn₂O₃ or MnO₂.

7. The process for purifying ammonia according to any one of claims 1 to 4, wherein said ratio between a number of manganese atom and a number of the entire metallic atoms of the effective component is 86 to 99%.

8. The process for purifying ammonia according to claim 2 or claim 4, wherein said synthetic zeolite has a pore diameter in the range of 3 to 10 Å.

9. The process for purifying ammonia according to any one of claims 1 to 4, wherein said impurities in the crude ammonia comprises at least one compound selected from oxygen, carbon monoxide, carbon dioxide and moisture.

10. The process for purifying ammonia according to claim 3 or claim 4, wherein said reproducing is carried out by feeding an inert gas to said purification agent and subsequently by feeding hydrogen or ammonia.

11. The process for purifying ammonia according to any one of claims 1 to 4, wherein a temperature contacting said crude ammonia with said purification agent is 150° C. or lower.

12. The process for purifying ammonia according to claim 2 or claim 4, wherein a temperature contacting said crude ammonia with said synthetic zeolite is 150° C. or lower.

13. The process for purifying ammonia according to claim 3 or claim 4, wherein a temperature for reproducing said purification agent is 160 to 400° C.

14. The process for purifying ammonia according to claim 4, wherein a temperature for reproducing said synthetic zeolite is 160 to 350° C.

15. The process for purifying ammonia according to claim 3, wherein the purification of ammonia is intermittently carried out by deploying at least two lines of purification line containing the purification agent in order to supply high purity ammonia continuously; and wherein the purification agent is intermittently reproduced by supplying a reproduction gas to the latter part of the purification line.

16. The process for purifying ammonia according to claim 4, wherein the purification of ammonia is intermittently carried out by deploying at least two lines of purification line containing both the purification agent and the synthetic zeolite in order to supply high purity ammonia continuously; and wherein the purification agent and the synthetic zeolite are intermittently reproduced by supplying a reproduction gas to the latter part of the purification line.
